(19) United States
(12) Patent Application Publication
(10) Pub. No.: US 2015/0312189 A1
(43) Pub. Date: Oct. 29, 2015

(54) METHOD OF AUTOMATICALLY RECEIVING NOTIFICATION APPLIED TO A PORTABLE DEVICE AND RELATED SYSTEM THEREOF

(71) Applicant: LBSTEK Inc, Taipei (TW)

(72) Inventor: Chiao-Ju Lee, Taipei (TW)

(21) Appl. No.: 14/695,028

(22) Filed: Apr. 23, 2015

(30) Foreign Application Priority Data
Apr. 23, 2014 (TW) 103114602

(51) Int. Cl. H04L 12/58; H04W 64/00; H04L 29/08

(52) U.S. Cl. CPC H04L 51/12; H04L 51/20; H04L 51/24; H04L 67/26; H04W 64/00; H04W 84/042

(57) ABSTRACT

A system of automatically receiving notification applied to a portable device includes a first portable device transmitting position coordinates thereof to a server; the server receiving the position coordinates, storing the position coordinates to a database of the server, and updating previous position coordinates of the first portable device according to the position coordinates; the server finding a second user within the database matching customization conditions of a first user having the first portable device according to the position coordinates and the customization conditions of the first user; the server simultaneously transmitting a first push notification message to the first portable device and a second push notification message to a second portable device of the second user according to a push notification function.

### FIELD OF THE INVENTION

The present invention relates to a method of automatically receiving notification applied to a portable device and a related system thereof, and particularly to a system of automatically receiving notification applied to a portable device and a related system thereof that can let a first user establish customization conditions thereof in a server to increase everyday life fun of the first user and decrease spams received by the first user.

### BACKGROUND

Generally speaking, a user having a portable device usually passively receives advertisement or messages provided by telecommunications providers through the portable device in everyday life, or passively receives dating messages from other portable devices through some predetermined application programs installed in the portable device. However, because the user having the portable device passively receives advertisement or messages provided by the telecommunications providers, or passively receives dating messages from the other portable devices, most of advertisement, messages, or dating messages not only are useless for the user, but also even disturb the user. That is to say, because the user cannot establish predetermined conditions corresponding to advertisement, messages, or dating messages, most of advertisement, messages, or dating messages are useless for the user. Therefore, the prior art are not a good choice for the user.

### SOME EXEMPLARY EMBODIMENTS

An embodiment provides a method of automatically receiving notification applied to a portable device. The method includes a first portable device transmitting coordinates thereof to a server; the server receiving the coordinates, storing the coordinates to a database of the server, and updating previous coordinates of the first portable device according to the coordinates; the server finding a second user within the database matching customization conditions of a first user having the first portable device according to the coordinates and the customization conditions of the first user; and the server simultaneously transmitting a first push notification message to the first portable device and a second push notification message to a second portable device of the second user according to a push notification function.

Another embodiment provides a method of automatically receiving notification applied to a portable device. The method includes a first portable device transmitting coordinates thereof to a server; the server receiving the coordinates, storing the coordinates to a database of the server, and updating previous coordinates of the first portable device according to the coordinates; and the server transmitting advertisement information to the first portable device according to the coordinates, customization conditions of a first user having the first portable device, and a push notification function.

Another embodiment provides a system of automatically receiving notification applied to a portable device. The system includes a first portable device and a server. The first portable device is used for transmitting coordinates thereof. The server is used for receiving the coordinates, storing the coordinates to a database of the server, updating previous coordinates of the first portable device according to the coordinates, finding a second user within the database matching customization conditions of the first user according to the coordinates and the customization conditions of a first user having the first portable device, and simultaneously transmitting a first push notification message to the first portable device and a second push notification message to a second portable device of the second user according to a push notification function.

Another embodiment provides a system of automatically receiving notification applied to a portable device. The system includes a first portable device and a server. The first portable device is used for transmitting coordinates thereof. The server is used for receiving the coordinates, storing the coordinates to a database of the server, updating previous coordinates of the first portable device according to the coordinates, and transmitting advertisement information to the first portable device according to the coordinates, customization conditions of a first user having the first portable device, and a push notification function.

The present invention provides a method of automatically receiving notification applied to a portable device and a related system thereof The method and the system utilize a server to find at least one second user within a database of the server matching customization conditions of a first user according to the customization conditions of the first user stored in the database of the server and current coordinates of the first user. After the server finds the at least one second user within the database of the server matching the customization conditions of the first user, the server also simultaneously determines whether the first user matches customization conditions of the at least one second user. If the first user also matches the customization conditions of the at least one second user, the server can utilize a push notification function to simultaneously transmit push notifications to a first portable device of the first user and at least one second portable device of the at least one second user. In addition, the server can also transmit advertisement information to the first portable device according to the customization conditions of the first user. Therefore, compared to the prior art, because the present invention can let the first user establish the customization conditions thereof in the database of the server, the present invention not only can increase everyday life fun of the first user, but can also decrease spams received by the first portable device of the first user.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The exemplary embodiments are illustrated by way of examples, and not by way of limitation, in the figures of the accompanying drawings in which like reference numerals refer to similar elements and in which:

FIG. 1 is a diagram illustrating a system of automatically receiving notification applied to a portable device according to an embodiment;

FIG. 2 is a flowchart illustrating a method of automatically receiving notification applied to a portable device according to another embodiment; and

FIG. 3 is a flowchart illustrating a method of automatically receiving notification applied to a portable device according to another embodiment.

### DESCRIPTION OF THE PREFERRED EMBODIMENT

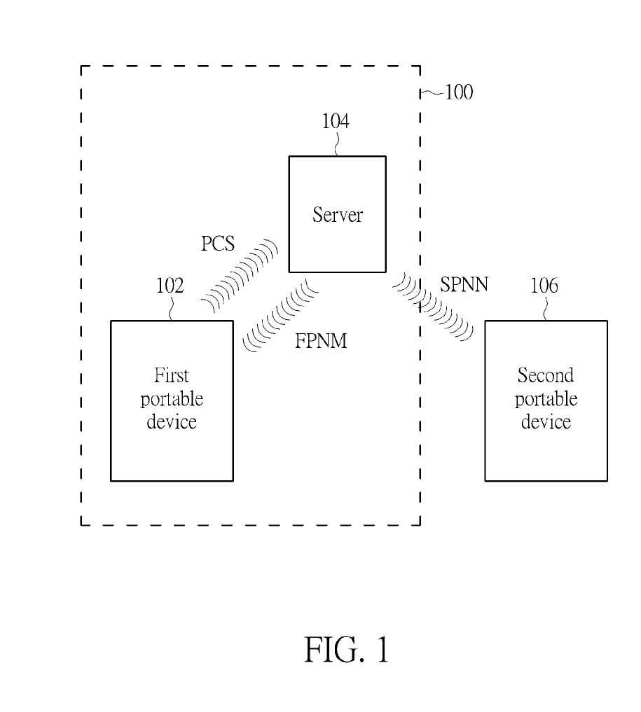

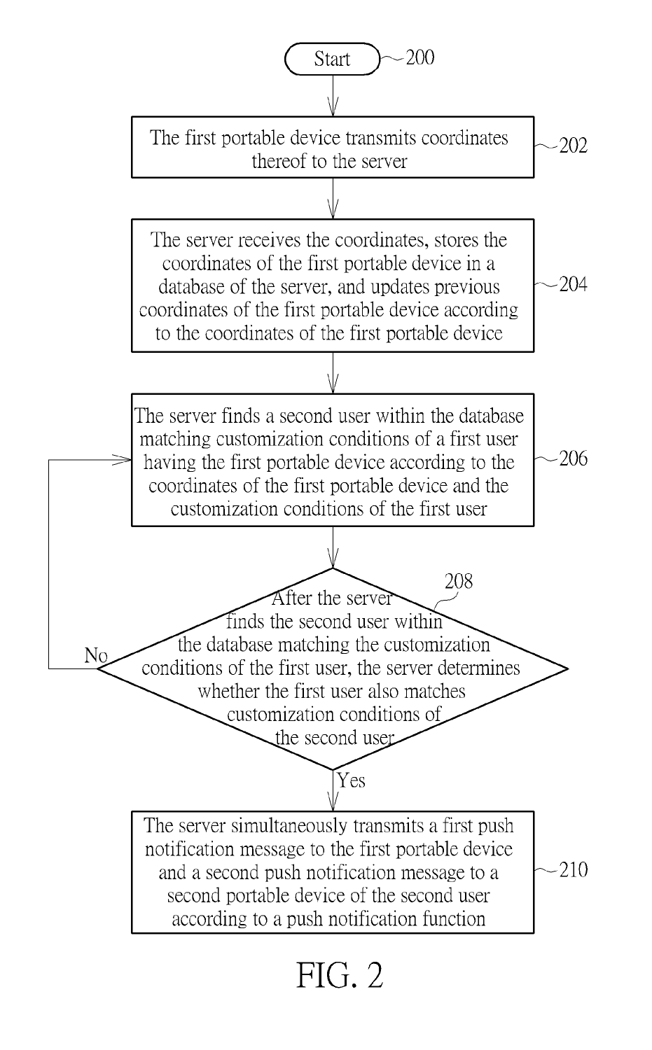

Please refer to FIG. 1 and FIG. 2. FIG. 1 is a diagram illustrating a system 100 of automatically receiving notification applied to a portable device according to an embodiment, and FIG. 2 is a flowchart illustrating a method of automatically receiving notification applied to a portable device according to another embodiment. As shown in FIG. 1, the system 100 includes a first portable device 102 and a server 104, wherein the first portable device 102 is a smart phone, a tablet computer, a personal digital assistant (PDA), or an e-book. Detailed steps in FIG. 2 are as follows:

Step 200: Start.

Step 202: The first portable device 102 transmits coordinates PCS thereof to the server 104.

Step 204: The server 104 receives the coordinates PCS, stores the coordinates PCS of the first portable device 102 in a database 1042 of the server 104, and updates previous coordinates of the first portable device 102 according to the coordinates PCS of the first portable device 102.

Step 206: The server 104 finds a second user within the database 1042 matching customization conditions of a first user having the first portable device 102 according to the coordinates PCS of the first portable device 102 and the customization conditions of the first user.

Step 208: After the server 104 finds the second user within the database 1042 matching the customization conditions of the first user, the server 104 determines whether the first user also matches customization conditions of the second user; if yes, go to Step 210; if no, go to Step 206.

Step 210: The server 104 simultaneously transmits a first push notification message FPNM to the first portable device 102 and a second push notification message SPNM to a second portable device 106 of the second user according to a push notification function.

In Step 202, the first portable device 102 transmits the coordinates PCS to the server 104 anytime and anywhere through a 2.5th generation (2.5G) mobile communication technology, a 3rd generation (3G) mobile communication technology, a 3.5th generation (3.5G) mobile communication technology, a 4th generation (4G) mobile communication technology, or a 5th generation (5G) mobile communication technology, and the coordinates PCS of the first portable device 102 are coordinates of Global Positioning System (GPS), coordinates of Global Navigation Satellite System (GLONASS), coordinates of BeiDou Navigation Satellite System (BDS), or coordinates of Galileo Positioning System, wherein an operation system of the first portable device 102 is Android™ iPhone™ OS WinMobile™, or Blackberry™ mobile phone operating system. In addition, regardless of whether the first portable device 102 enables a supported application program or not, the first portable device 102 can still transmit the coordinates PCS to the server 104 anytime and anywhere. In Step 204, after the server 104 receives the coordinates PCS of the first portable device 102, the server 104 can store the coordinates PCS of the first portable device 102 in the database 1042 of the server 104, and update the previous coordinates of the first portable device 102 stored in the database 1042 according to the coordinates PCS of the first portable device 102. In Step 206, the first user can establish the customization conditions of the first user according to requirements of the first user, and store the customization conditions of the first user in the database 1042 of the server 104 through the first portable device 102, wherein the customization conditions of the first user can include a combination of age, education, sex, height, weight, nationality, and race of other users, a first predetermined distance (e.g. 100 meters) between portable devices of other users and the first portable device 102, a first predetermined time, a predetermined holiday (e.g. Valentine's Day), and a predetermined location (e.g. a bookstore or a restaurant). But, the present invention is not limited to the customization conditions of the first user including a combination of age, education, sex, height, weight, nationality, and race of other users, a first predetermined distance between portable devices of other users and the first portable device 102, a first predetermined time, a predetermined holiday, and a predetermined location. Therefore, the server 104 can find the second user within the database 1042 matching the customization conditions of the first user according to the coordinates PCS of the first portable device 102 and the customization conditions of the first user, wherein the second user matching the customization conditions of the first user can be a predetermined member (but the present invention is not limited to the second user matching the customization conditions of the first user being a predetermined member). For example, if the customization conditions of the first user are everyday noon (12:00-13:00) and a predetermined restaurant, when the first user having the first portable device 102 appears at the predetermined restaurant at noon (12:00-13:00) of a day, the server 104 can find the second user (that is, the second user having a second portable device 106 also appearing at the predetermined restaurant at noon (12:00-13:00) of the day) matching the customization conditions of the first user from the database 1042 according to the coordinates PCS (corresponding to the predetermined restaurant) of the first portable device 102. In Step 208, after the server 104 finds the second user matching the customization conditions of the first user within the database 1042 according to the coordinates PCS of the first portable device 102 and the customization conditions of the first user, the server 104 can also simultaneously determine whether the first user matches the customization conditions of the second user. In Step 210, if the first user also matches the customization conditions of the second user, the server 104 can simultaneously transmit the first push notification message FPNM to the first portable device 102 and the second push notification message SPNM to the second portable device 106 of the second user according to the push notification function (e.g. Apple Push Notification Service or Google Cloud Message) supported by the operation system of the first portable device 102 through the 2.5G mobile communication technology, the 3G mobile communication technology, the 3.5G mobile communication technology, the 4G mobile communication technology, or the 5G mobile communication technology, wherein the second portable device 106 is a smart phone, a tablet computer, a personal digital assistant (PDA), or an e-book. But, in another embodiment of the present invention, after the server 104 finds the second user within the database 1042 matching the customization conditions of the first user according to the coordinates PCS of the first portable device 102 and the customization conditions of the first user, the server 104 does not determine whether the first user also matches the customization conditions of the second user, so the server 104 can directly transmit the first push notification message FPNM to the first portable device 102 and the second push notification message SPNM to the second portable device 106 of the second user after the server 104 finds the second user within the database 1042 matching the customization conditions of the first user. The first push notification message FPNM transmitted to the first portable device 102 by the server 104 includes a personal profile (e.g. age, education, sex, height, weight, nationality, or race of the second user) of the second user having the second portable device 106, photos of the second user, and a number of the first push notification message FPNM within a predetermined time (e.g. one day or one week), wherein the first user can determine whether the second user is more destined to the first user according to the number of the first push notification message FPNM within the predetermined time. Similarly, the second push notification message SPNM transmitted to the second portable device 106 by the server 104 includes a personal profile (e.g. age, education, sex, height, weight, nationality, or race of the first user) of the first user, the photos of the first user, and a number of the second push notification message SPNM within the predetermined time (e.g. one day or one week).

In addition, the present invention is not limited to only one second user. That is to say, the server 104 can execute the present invention on the first user and a plurality of second users when the server 104 finds the plurality of second users within the database 1042 matching the customization conditions of the first user, and the first user also matches customization conditions of the plurality of second users according to the coordinates PCS of the first portable device 102 and the customization conditions of the first user.

In addition, the first user can also actively utilize a polling method to directly browse a number of first push notification messages corresponding to at least one predetermined second user or corresponding to all second users within the predetermined time (e.g. one day or one week) stored in the database 1042 of the server 104.

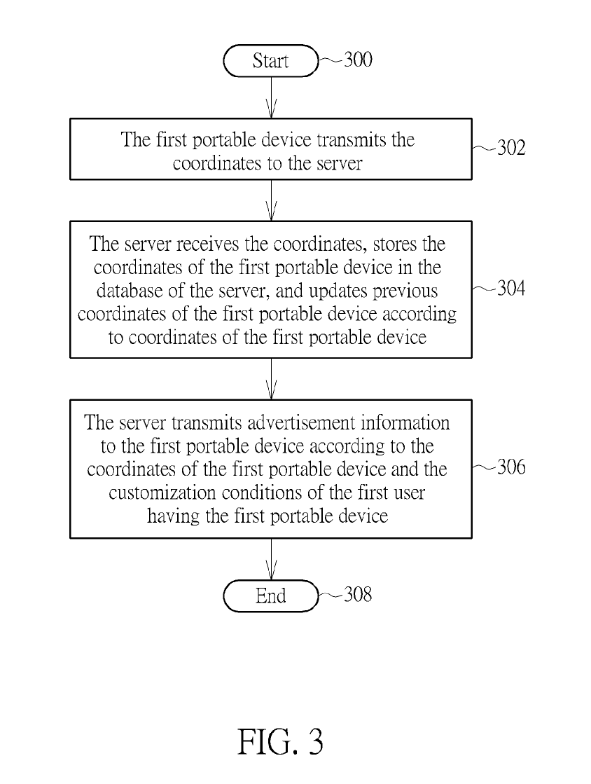

Please refer to FIG. 3. FIG. 3 is a flowchart illustrating a method of automatically receiving notification applied to a portable device according to another embodiment. The method in FIG. 3 is illustrated using the system 100 in FIG. 1. Detailed steps are as follows:

Step 300: Start.

Step 302: The first portable device 102 transmits the coordinates PCS to the server 104.

Step 304: The server 104 receives the coordinates PCS, stores the coordinates PCS of the first portable device 102 in the database 1042 of the server 104, and updates previous coordinates of the first portable device 102 according to coordinates PCS of the first portable device 102.

Step 306: The server 104 transmits advertisement information to the first portable device 102 according to the coordinates PCS of the first portable device 102 and the customization conditions of the first user having the first portable device 102.

Step 308: End.

A difference between the embodiment in FIG. 3 and the embodiment in FIG. 2 is that in Step 306, the server 104 transmits the advertisement information to the first portable device 102 according to the coordinates PCS of the first portable device 102 and the customization conditions of the first user having the first portable device 102. For example, the customization conditions of the first user can include a predetermined place (e.g. a fast-food restaurant, a Chinese-food restaurant, a scenic spot, and so on) away from the first portable device 102 within a predetermined distance. Therefore, when the predetermined place is away from the first portable device 102 within the predetermined distance, the server 104 can transmit the advertisement information corresponding to the predetermined place to the first portable device 102 according to the coordinates PCS of the first portable device 102 and the customization conditions of the first user. In addition, subsequent operational principles of the embodiment in FIG. 3 are the same as those of the embodiment in FIG. 2, so further description thereof is omitted for simplicity.

To sum up, the method of automatically receiving notification applied to a portable device and the related system utilize the server to find at least one second user within the database of the server matching the customization conditions of the first user according to the customization conditions of the first user stored in the database of the server and current coordinates of the first user. After the server finds the at least one second user within the database of the server matching the customization conditions of the first user, the server also simultaneously determines whether the first user matches customization conditions of the at least one second user. If the first user also matches the customization conditions of the at least one second user, the server can utilize the push notification function to simultaneously transmit push notifications to the first portable device and the second portable device. In addition, the server can also transmit advertisement information to the first portable device according to the customization conditions of the first user. Therefore, compared to the prior art, because the present invention can let the first user establish the customization conditions thereof in the database of the server, the present invention not only can increase everyday life fun of the first user, but can also decrease spams received by the first portable device of the first user.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of automatically receiving notification applied to a portable device, comprising:
a first portable device transmitting coordinates thereof to a server;
the server receiving the coordinates, storing the coordinates to a database of the server, and updating previous coordinates of the first portable device according to the coordinates;
the server finding a second user within the database matching customization conditions of a first user having the first portable device according to the coordinates and the customization conditions of the first user; and
the server simultaneously transmitting a first push notification message to the first portable device and a second push notification message to a second portable device of the second user according to a push notification function.

2. The method of claim 1, wherein the coordinates are coordinates of Global Positioning System (GPS), coordinates of Global Navigation Satellite System (GLONASS), coordinates of BeiDou Navigation Satellite System (BDS), or coordinates of Galileo Positioning System.

3. The method of claim 1, wherein the customization conditions of the first user are a combination of a first predetermined time and a first predetermined distance.

4. The method of claim 1, wherein the first portable device transmits the coordinates thereof to the server through a 2.5th generation (2.5G) mobile communication technology, a 3rd generation (3G) mobile communication technology, a 3.5th generation (3.5G) mobile communication technology, a 4th generation (4G) mobile communication technology, or a 5th generation (5G) mobile communication technology.

5. The method of claim 1, wherein the first push notification message comprises a combination of a personal profile and photos of the second user, and a number of first push notification messages within a predetermined time.

6. The method of claim 1, wherein the second push notification message comprises a personal profile and photos of the first user, and a number of second push notification messages within a predetermined time.

7. The method of claim 1, further comprising:
when the first user also matches customization conditions of the second user, the server simultaneously transmitting the first push notification message to the first portable device and the second push notification message to the second portable device of the second user according to the push notification function, wherein the customization conditions of the second user are a combination of a second predetermined time and a second predetermined distance.

8. The method of claim 1, wherein the server transmits the first push notification message to the first portable device and the second push notification message to the second portable device through a 2.5G mobile communication technology, a 3G mobile communication technology, a 3.5G mobile communication technology, a 4G mobile communication technology, or a 5G mobile communication technology.

9. A method of automatically receiving notification applied to a portable device, comprising:
a first portable device transmitting coordinates thereof to a server;
the server receiving the coordinates, storing the coordinates to a database of the server, and updating previous coordinates of the first portable device according to the coordinates; and
the server transmitting advertisement information to the first portable device according to the coordinates, customization conditions of a first user having the first portable device, and a push notification function.

10. The method of claim 9, wherein the server transmits the advertisement information to the first portable device through a 2.5G mobile communication technology, a 3G mobile communication technology, a 3.5G mobile communication technology, a 4G mobile communication technology, or a 5G mobile communication technology.

11. A system of automatically receiving notification applied to a portable device, comprising:
a first portable device for transmitting coordinates thereof; and
a server for receiving the coordinates, storing the coordinates to a database of the server, updating previous coordinates of the first portable device according to the coordinates, finding a second user within the database matching customization conditions of the first user according to the coordinates and the customization conditions of a first user having the first portable device, and simultaneously transmitting a first push notification message to the first portable device and a second push notification message to a second portable device of the second user according to a push notification function.

12. The system of claim 11, wherein the coordinates are coordinates of GPS, coordinates of GLONASS, coordinates of BDS, or coordinates of Galileo Positioning System.

13. The system of claim 11, wherein the customization conditions of the first user are a combination of a first predetermined time and a first predetermined distance.

14. The system of claim 11, wherein the first portable device transmits the coordinates thereof to the server through a 2.5G mobile communication technology, a 3G mobile communication technology, a 3.5G mobile communication technology, a 4G mobile communication technology, or a 5G mobile communication technology.

15. The system of claim 11, wherein the first push notification message comprises a combination of a personal profile and photos of the second user and a number of first push notification messages within a predetermined time.

16. The system of claim 11, wherein the second push notification message comprises a personal profile and photos of the first user and a number of second push notification messages within a predetermined time.

17. The system of claim 11, wherein when the first user also matches customization conditions of the second user, the server is further used for simultaneously transmitting the first push notification message to the first portable device and the second push notification message to the second portable device of the second user according to the push notification function, wherein the customization conditions of the second user are a combination of a second predetermined time and a second predetermined distance.

18. The system of claim 11, wherein the server transmits the first push notification message to the first portable device and the second push notification message to the second portable device through a 2.5G mobile communication technology, a 3G mobile communication technology, a 3.5G mobile communication technology, a 4G mobile communication technology, or a 5G mobile communication technology.

19. A system of automatically receiving notification applied to a portable device, comprising:
a first portable device for transmitting coordinates thereof; and
a server for receiving the coordinates, storing the coordinates to a database of the server, updating previous coordinates of the first portable device according to the coordinates, and transmitting advertisement information to the first portable device according to the coordinates, customization conditions of a first user having the first portable device, and a push notification function.

20. The system of claim 19, wherein the server transmits the advertisement information to the first portable device through a 2.5G mobile communication technology, a 3G mobile communication technology, a 3.5G mobile communication technology, a 4G mobile communication technology, or a 5G mobile communication technology.
